(19) United States
(12) Patent Application Publication
(10) Pub. No.: US 2024/0409061 A1
(43) Pub. Date: Dec. 12, 2024

(54) Multi Alarm Device

(71) Applicant: Phyllis Lewis, Black Jack, MO (US)

(72) Inventor: Phyllis Lewis, Black Jack, MO (US)

(21) Appl. No.: 18/503,284

(22) Filed: Nov. 7, 2023

Related U.S. Application Data
(60) Provisional application No. 63/506,923, filed on Jun. 8, 2023.

(51) Int. Cl. B60R 25/104; B60R 25/01; B60R 25/102; B60R 25/40

(52) U.S. Cl. CPC B60R 25/104; B60R 25/01; B60R 25/102; B60R 25/403; B60R 2025/1016

(57) ABSTRACT

A multi-alarm device is disclosed that is a specialized vehicle security device designed to work in conjunction with a key fob, home security system, and mobile application. The multi-alarm device comprises a lock component which communicates with the vehicle as well as with multiple control devices, such as a mobile application, a key fob, and a home security system. When the vehicle is tampered with, at least one of the control devices is alerted, and the vehicle locks the transmission, doors, steering, wheels, and brakes. Further, the vehicle's horn sounds and the internal and external lights blink. The windshield wipers also turn on to draw attention and impair visibility. The vehicle may also play a pre-recorded song to draw attention.

### CROSS-REFERENCE TO RELATED APPLICATION

The present application claims priority to, and the benefit of, U.S. Provisional Application No. 63/506,923, which was filed on Jun. 8, 2023, and is incorporated herein by reference in its entirety.

### FIELD OF THE INVENTION

The present invention relates generally to the field of multi-alarm devices. More specifically, the present invention relates to a vehicle security system with the ability to connect to various control devices, such as a key fob or a mobile application. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in multi-alarm devices. Generally, car theft is a huge issue that never seems to find an effective solution. Traditional car alarms are only somewhat effective at deterring theft. Further, although an audible alert may sound, the vehicle may still be moved from its location, resulting in vehicle theft, high insurance claims, higher premiums, carjackings, police chases, etc.

Furthermore, even with a car alarm, a car or other vehicle can be moved and/or broken into, causing significant damage and loss. Typical car alarms merely emit sounds and do not prevent the car from being moved and/or broken into.

Accordingly, there is a demand for an improved multi-alarm device that connects to various control devices, such as a key fob or mobile application. More particularly, there is a demand for a multi-alarm device that prevents a vehicle from being moved from its location in the event of a break-in or tampering.

Therefore, there exists a long felt need in the art for a multi-alarm device that provides users with a vehicle security system with the ability to connect to various control devices, such as a key fob or mobile application. There is also a long felt need in the art for a multi-alarm device that prevents a vehicle from being moved from its location in the event of a break-in or tampering. Further, there is a long felt need in the art for a multi-alarm device that decreases the occurrence of vehicle theft by ensuring that the vehicle cannot be mobilized and that the owner and bystanders are instantly alerted. Moreover, there is a long felt need in the art for a device that locks down the vehicle's tires, steering system, doors, and brakes and turns on the windshield wipers. Further, there is a long felt need in the art for a multi-alarm device that sends alerts to the owner using the mobile application while also emitting loud sounds, horn honking, music, etc. Finally, there is a long felt need in the art for a multi-alarm device that is designed to work in conjunction with a key fob, home security system, and mobile application.

The subject matter disclosed and claimed herein, in one embodiment thereof, comprises a multi-alarm device. The device is a specialized vehicle security device that is designed to work in conjunction with a key fob, home security system, and mobile application. The multi-alarm device comprises a lock component which communicates with the vehicle as well as with multiple control devices, such as a mobile application, a key fob, and a home security system. When the vehicle is tampered with, at least one of the control devices is alerted, and the vehicle locks the transmission, doors, steering, wheels, and brakes. Further, the vehicle's horn sounds and the internal and external lights blink. The windshield wipers also turn on to draw attention and impair visibility. The vehicle may also play a pre-recorded song to draw attention. Thus, the device can be helpful to prevent vehicle break-ins, theft, vandalism, and catalytic converter theft.

In this manner, the multi-alarm device of the present invention accomplishes all of the forgoing objectives and provides users with a device that prevents a vehicle from being moved from its location in the event of a break-in. The device locks down the vehicle's tires, steering system, doors, and brakes and turns on the windshield wipers. The device sends alerts to the owner using the mobile application, key fob, and/or home security system.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a multi-alarm device. The device is a specialized vehicle security device that is designed to work in conjunction with a key fob, home security system, and mobile application. The multi-alarm device comprises a lock component which communicates with the vehicle as well as with multiple control devices, such as a mobile application, a key fob, and a home security system. When the vehicle is tampered with, at least one of the control devices is alerted, and the vehicle locks the transmission, doors, steering, wheels, and brakes. Further, the vehicle's horn sounds and the internal and external lights blink. The windshield wipers also turn on to draw attention and impair visibility. The vehicle may also play a pre-recorded song to draw attention. Thus, the device can be helpful to prevent vehicle break-ins, theft, vandalism, and catalytic converter theft.

In one embodiment, the multi-alarm device comprises a lock component, which is specifically an electronic module that is adapted to provide detection and alarm functions. The lock component comprises at least one sensor module, an alarm, a microprocessor, a transceiver, a memory, a power supply unit, and a securing means. Any other suitable hardware and software can be utilized to communicate with the lock component, the vehicle, and the user, as is known in the art.

In one embodiment, the at least one sensor module comprises a horizontal motion sensor, a vertical motion sensor, and an infrared sensor. The horizontal motion sensor is used to detect horizontal vibration of the vehicle (i.e., such as opening doors). The vertical motion sensor is used to detect vertical vibration of the vehicle (i.e., such as entering the vehicle). The infrared sensor is used to detect movement of an object (i.e., such as a human body) in the vehicle. The vehicle stands at a static status after the lock component enables the sensor module, and the vehicle will change from the static status to a motion status when the door is opened, when the vehicle is entered, or when a human body is detected moving in the vehicle.

If the vehicle changes to a motion status, the sensor module immediately sends a signal of detection to the microprocessor and the alarm. Upon receipt of the signal of detection, the microprocessor outputs the signal of detection via the transceiver to a control device. Further, the transceiver can also receive a signal of setting from the control device and then outputs the received signal of setting to the microprocessor.

In one embodiment, the alarm can be the vehicle's horn honking, external and internal lights blinking, the windshield wipers turning on to draw attention and impair visibility, and/or the vehicle can play a pre-recorded song to draw attention. When receiving a signal of detection, the alarm produces any and all of the identified examples, depending on the user's wants and/or needs, as well as what alarm specifics were programmed into the lock component via the user.

In one embodiment, the lock component also comprises a securing means for locking the transmission, the doors, the steering system, the wheels, and the brakes, depending on the needs and/or wants of a user, when the alarm is engaged. Thus, besides an audio and/or visual alarm, when the signal of detection is sent, the securing means is then activated, as well. The securing means controls the locking and unlocking of the vehicle's transmission, doors, steering system, wheels, and brakes, thus, disabling the vehicle and preventing the vehicle from moving when the alarm is engaged.

In one embodiment, the control device comprises a key fob, a mobile application and a home security system. In this embodiment, the lock component can communicate with all of the control devices, depending on the needs and/or wants of a user. Specifically, the multi-alarm device includes a wireless communications module and additional sensors which would allow the device to pair with a mobile application on a smart device, a key fob, or a home security system. Once paired, a user could control the multi-alarm device via the mobile application, the home security system, and the key fob. Further, each of the control devices comprises a plurality of function keys for operation by the user to enable or disable the lock component and to determine whether the sensor module has been breached. Further, the function keys allow the user to determine which alarm example and/or securing means is performed when a sensor module has been breached.

Additionally, the lock component is adapted to receive the signal of detection from the transceiver, it outputs the received signal of detection to the microprocessor. Upon receiving the signal from the transceiver, the microprocessor communicates with both the alarm and the multiple control devices, causing the alarms to sound and communicating with a user (i.e., owner of the vehicle).

In one embodiment, the power supply unit comprises a plurality of DC batteries mounted therein for providing necessary working power to the elements contained in the lock component. The power supply unit further comprises a power detector and a power alarm. The power detector detects the power status of the power supply unit and enables the power alarm when the power status is low. The power alarm can be an LED (Light Emitting Diode) as a visual alarm, and a buzzer as an audio alarm. When the power of the power supply unit drops below a predetermined low level, the power detector activates the power alarm to send a visual or audio alarm signal to the user.

In yet another embodiment, the multi-alarm device comprises a plurality of indicia.

In yet another embodiment, a method of securing a vehicle and preventing a vehicle from being moved from its location is disclosed. The method includes the steps of providing a multi-alarm device comprising a lock component which communicate with the vehicle and multiple control devices, such as a mobile application, a key fob, and a home security system. The method also comprises engaging the lock component and setting the alarm. Further, the method comprises if the vehicle is tampered with, communicating with the lock component and multiple control devices. The method also comprises activating at least one control device to send an alert to a user. Finally, the method comprises locking the vehicle's transmission, doors, steering system, wheels, and brakes to prevent movement.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the multi-alarm device of the present invention showing a tampered vehicle activating its lights and horn in accordance with the disclosed architecture;

FIG. 2 illustrates a perspective view of one embodiment of the multi-alarm device of the present invention showing how the wheels of the vehicle lock in accordance with the disclosed architecture;

FIG. 3 illustrates a perspective view of one embodiment of the multi-alarm device of the present invention showing an alert sent to the mobile application in accordance with the disclosed architecture;

FIG. 4 illustrates a perspective view of one embodiment of the multi-alarm device of the present invention showing an alert sent to the key fob in accordance with the disclosed architecture;

FIG. 5 illustrates a perspective view of one embodiment of the multi-alarm device of the present invention showing the key fob in use in accordance with the disclosed architecture; and

FIG. 6 illustrates a flowchart showing the method of securing a vehicle and preventing a vehicle from being moved from its location in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a multi-alarm device that provides users with a vehicle security system with the ability to connect to various control devices, such as a key fob or mobile application. There is also a long felt need in the art for a multi-alarm device that prevents a vehicle from being moved from its location in the event of a break-in or tampering. Further, there is a long felt need in the art for a multi-alarm device that decreases the occurrence of vehicle theft by ensuring that the vehicle cannot be mobilized and that the owner and bystanders are instantly alerted. Moreover, there is a long felt need in the art for a device that locks down the vehicle's tires, steering system, doors, and brakes and turns on the windshield wipers. Further, there is a long felt need in the art for a multi-alarm device that sends alerts to the owner using the mobile application while also emitting loud sounds, horn honking, music, etc. Finally, there is a long felt need in the art for a multi-alarm device that is designed to work in conjunction with a key fob, home security system, and mobile application.

The present invention, in one exemplary embodiment, is a novel multi-alarm device. The device is a specialized vehicle security device that is designed to work in conjunction with a key fob, home security system, and mobile application. The multi-alarm device comprises a lock component which communicates with the vehicle as well as with multiple control devices, such as a mobile application, a key fob, and a home security system. When the vehicle is tampered with, at least one of the control devices is alerted, and the vehicle locks the transmission, doors, steering, wheels, and brakes. Further, the vehicle's horn sounds and the internal and external lights blink, and windshield wipers turn on. The present invention also includes a novel method of securing a vehicle and preventing a vehicle from being moved from its location. The method includes the steps of providing a multi-alarm device comprising a lock component which communicates with the vehicle and multiple control devices, such as a mobile application, a key fob, and a home security system. The method also comprises engaging the lock component and setting the alarm. Further, the method comprises if the vehicle is tampered with, communicating with the lock component and multiple control devices. The method also comprises activating at least one control device to send an alert to a user. Finally, the method comprises locking the vehicle's transmission, doors, steering system, wheels, and brakes to prevent movement.

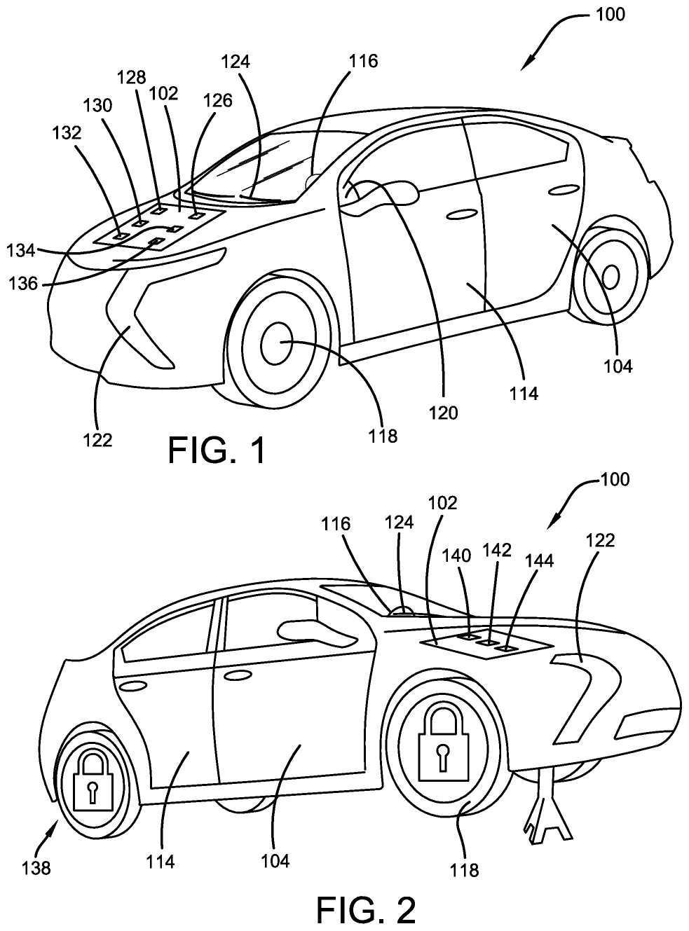

Referring initially to the drawings, FIG. 1 illustrates a perspective view of one embodiment of the multi-alarm device 100 of the present invention. In the present embodiment, the multi-alarm device 100 is an improved multi-alarm device 100 that is a specialized vehicle security device that connects to multiple control devices 106, such as a key fob 110, mobile application 108, or home security system 112. Specifically, the multi-alarm device 100 comprises a lock component 102 which communicates with the vehicle 104 as well as with multiple control devices 106, such as a mobile application 108, a key fob 110, and a home security system 112. When the vehicle 104 is tampered with, at least one of the control devices 106 is alerted, and the vehicle 104 locks the transmission, doors 114, steering 116, wheels 118, and brakes. Further, the vehicle's horn 120 sounds and the internal and external lights 122 blink. The windshield wipers 124 also turn on to draw attention and impair visibility. The vehicle 104 may also play a pre-recorded song to draw attention. Thus, the device 100 can be helpful to prevent vehicle break-ins, theft, vandalism, and catalytic converter theft.

Generally, the multi-alarm device 100 comprises a lock component 102, which is specifically an electronic module that is adapted to provide detection and alarm functions. The lock component 102 is typically housed within the vehicle 104 and is in communication with the vehicle's computer and other electronic systems, as well as in communication with a user's control device 106. The lock component 102 comprises at least one sensor module 126, an alarm 128, a microprocessor 130, a transceiver 132, a memory 134, a power supply unit 136, and a securing means 138. Any other suitable hardware and software can be utilized to communicate with the lock component 102, the vehicle 104, and the user (i.e., the control device 106), as is known in the art.

Furthermore, the at least one sensor module 126 comprises a horizontal motion sensor 140, a vertical motion sensor 142, and an infrared sensor 144. The horizontal motion sensor 140 is used to detect horizontal vibration of the vehicle 104 (i.e., such as opening doors 114). The vertical motion sensor 142 is used to detect vertical vibration of the vehicle 104 (i.e., such as entering the vehicle 104). The infrared sensor 144 is used to detect movement of an object (i.e., such as a human body) in the vehicle 104. The vehicle 104 stands at a static status after the lock component 102 enables the sensor module 126, and the vehicle 104 will change from the static status to a motion status when the door 114 is opened, when the vehicle 104 is entered, or when a human body is detected moving in the vehicle 104.

If the vehicle 104 changes to a motion status, the sensor module 126 immediately sends a signal of detection to the microprocessor 130 and the alarm 128. Upon receipt of the signal of detection, the microprocessor 130 outputs the signal of detection via the transceiver 132 to a control device 106. Further, the transceiver 132 can also receive a signal of setting from the control device 106 and then outputs the received signal of setting to the microprocessor 130.

Generally, when activated by the lock component 102, the alarm 128 can be the vehicle's horn 120 honking, external and internal lights 122 blinking, the windshield wipers 124 turning on to draw attention and impair visibility, and/or the vehicle 104 can play a pre-recorded song to draw attention. When receiving a signal of detection, the alarm 128 produces any and all of the identified examples, depending on the user's wants and/or needs, as well as what alarm specifics were programmed into the lock component 102 via the user.

As shown in FIG. 2, the lock component 102 also comprises a securing means 138 for locking the transmission, the doors 114, the steering system 116, the wheels 118, and the brakes, depending on the needs and/or wants of a user, when the alarm 128 is engaged. Thus, besides an audio and/or visual alarm, when the signal of detection is sent, the securing means 138 is then activated, as well. The securing means 138 controls the locking and unlocking of the vehicle's transmission, doors 114, steering system 116, wheels 118, and brakes, thus, disabling the vehicle 104 and preventing the vehicle 104 from moving when the alarm 128 is engaged. Any suitable hardware and/or software can be utilized to lock and unlock the vehicle's transmission, doors 114, steering system 116, wheels 118, and brakes to disable the vehicle 104 and prevent movement.

Additionally, the lock component 102 is adapted to receive the signal of detection from the transceiver 132, it outputs the received signal of detection to the microprocessor 130. Upon receiving the signal from the transceiver 132, the microprocessor 130 communicates with both the alarm 128 and the multiple control devices 106, causing the alarms 128 to sound and communicating with a user (i.e., owner of the vehicle 104 via the control devices 106).

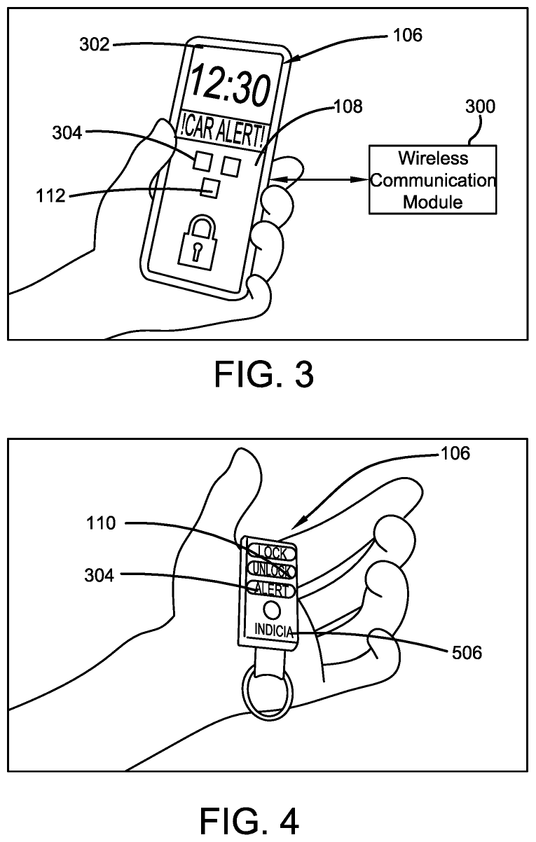

As shown in FIGS. 3-4, the control device 106 comprises a key fob 110, a mobile application 108 and a home security system 112. In this embodiment, the lock component 102 can communicate with all of the control devices 106, depending on the needs and/or wants of a user. Specifically, the multi-alarm device 100 includes a wireless communications module 300 and additional sensors which would allow the device 100 to pair with a mobile application 108 on a smart device 302, a key fob 110, or a home security system 112. Once paired, a user could control the multi-alarm device 100 via the mobile application 108, the home security system 112, and the key fob 110.

Further, the mobile device or smart device 302 may be a cellular telephone, a remote control, or any other device that may have wireless communication capabilities and may be connected to the internet. The mobile or smart device 302 may perform any type of wireless communication, including, but not limited to, WIFI, BLUETOOTH, RFID, NFC, etc. The device 100 further includes a wireless communication module 300 and additional sensors which would allow the device 100 to pair with a mobile application 108 on a mobile or smart device 302, the key fob 110, or the home security system 112. Once paired, a user could control the multi-alarm device 100 via the mobile application 108, the home security system 112, and the key fob 110.

As such, the user may use a mobile or smart device 302 to input and/or program a date and time that the multi-alarm device 100 is scheduled to set the alarm 128 via the lock component 102, and a signal may be sent from the mobile device 302 to the transmitter/receiver 132 such that the microprocessor 130 (which may include a storage device) stores the date and time that the multi-alarm device 100 is scheduled to engage the alarm 128. Alternatively, the mobile or smart device 302 may send a signal to the transmitter/receiver 132 to control the multi-alarm device 100 to engage the alarm 128 immediately.

Further, each of the control devices 106 comprises a plurality of function keys 304 for operation by the user to enable or disable the lock component 102 and to determine whether the sensor module 126 has been breached. Further, the function keys 304 allow the user to determine which alarm 128 example and/or securing means 138 is performed when a sensor module 126 has been breached.

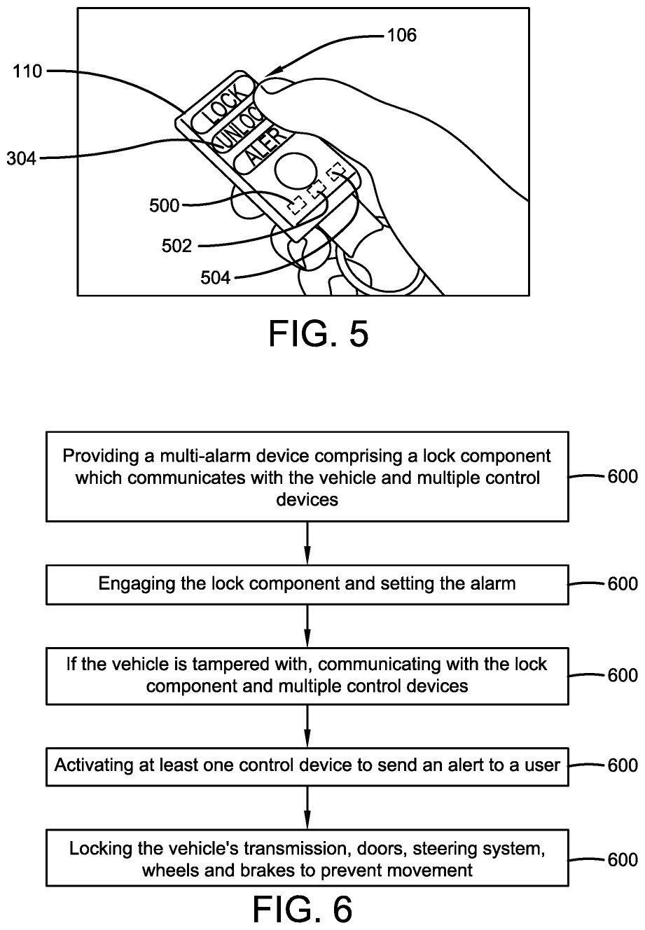

As shown in FIG. 5, the power supply unit 136 comprises a plurality of DC batteries 500 mounted therein for providing necessary working power to the elements contained in the lock component 102. The power supply unit 136 further comprises a power detector 502 and a power alarm 504. The power detector 502 detects the power status of the power supply unit 136 and enables the power alarm 504 when the power status is low. The power alarm 504 can be an LED (Light Emitting Diode) as a visual alarm, and a buzzer as an audio alarm. When the power of the power supply unit 136 drops below a predetermined low level, the power detector 502 activates the power alarm 504 to send a visual or audio alarm signal to the user.

In another embodiment, the power supply unit 136 comprises a plurality of batteries 500. The batteries 500 may be a disposable battery or a rechargeable battery in the form of an alkaline, nickel-cadmium, nickel-metal hydride battery, etc., such as any 3V-12 volts DC battery or other conventional battery, such as A, AA, AAA, etc., that supplies power to the multi-alarm device 100. Throughout this specification, the term “battery” may be used interchangeably to refer to one or more wet or dry cells or batteries of cells in which chemical energy is converted into electricity and used as a source of DC power. References to recharging or replacing the battery 500 may refer to recharging or replacing individual cells, individual batteries of cells, or a package of multiple battery cells as is appropriate for any given battery technology that may be used. In addition, a rechargeable embodiment of the battery 500 may be recharged using a USB port (not shown), wherein the USB port is a USB-A, USB-B, Micro-B, Micro-USB, Mini-USB, or USB-C port, etc.

In yet another embodiment, the multi-alarm device 100 comprises a plurality of indicia 506. The lock component 102 of the device 100 may include advertising, a trademark, or other letters, designs, or characters, printed, painted, stamped, or integrated into the lock component 102, or any other indicia 506 as is known in the art. Specifically, any suitable indicia 506 as is known in the art can be included, such as but not limited to, patterns, logos, emblems, images, symbols, designs, letters, words, characters, animals, advertisements, brands, etc., that may or may not be vehicle, alarm, or brand related.

FIG. 6 illustrates a flowchart of the method of securing a vehicle and preventing a vehicle from being moved from its location. The method includes the steps of at 600, providing a multi-alarm device comprising a lock component which communicate with the vehicle and multiple control devices, such as a mobile application, a key fob, and a home security system. The method also comprises at 602, engaging the lock component and setting the alarm. Further, the method comprises at 604, if the vehicle is tampered with, communicating with the lock component and multiple control devices. The method also comprises at 606, activating at least one control device to send an alert to a user. Finally, the method comprises at 608, locking the vehicle's transmission, doors, steering system, wheels, and brakes to prevent movement.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “multi-alarm device” and “device” are interchangeable and refer to the multi-alarm device 100 of the present invention.

Notwithstanding the forgoing, the multi-alarm device 100 of the present invention can be of any suitable size and configuration as is known in the art without affecting the overall concept of the invention, provided that it accomplishes the above stated objectives. One of ordinary skill in the art will appreciate that the multi-alarm device 100 as shown in FIGS. 1-6 is for illustrative purposes only, and that many other sizes and shapes of the multi-alarm device 100 are well within the scope of the present disclosure. Although the dimensions of the multi-alarm device 100 are important design parameters for user convenience, the multi-alarm device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A multi-alarm device that is a specialized vehicle security device, the multi-alarm device comprising:
a lock component;
at least one control device;
at least one alarm; and
at least one securing means;
wherein the lock component communicates with a vehicle and with the at least one control device to alert a user;
wherein when the vehicle is tampered with the at least one control device is alerted, the at least one securing means locks vehicular components, and the at least one alarm is engaged; and
further wherein the multi-alarm device prevents vehicle break-ins, theft, vandalism, and catalytic converter theft.

2. The multi-alarm device of claim 1, wherein the lock component is an electronic module that is adapted to provide detection and alarm functions and is housed within the vehicle and is in communication with the vehicle's computer and other electronic systems, as well as in communication with the at least one control device.

3. The multi-alarm device of claim 2, wherein the lock component comprises at least one sensor module, an alarm, a microprocessor, a transceiver, a memory, a power supply unit, and the at least one securing means.

4. The multi-alarm device of claim 3, wherein the at least one sensor module comprises a horizontal motion sensor, a vertical motion sensor, and an infrared sensor.

5. The multi-alarm device of claim 4, wherein if the vehicle is tampered with, the at least one sensor module immediately sends a signal of detection to the microprocessor and the at least one alarm; upon receipt of the signal of detection, the microprocessor outputs the signal of detection via the transceiver to the at least one control device.

6. The multi-alarm device of claim 5, wherein the transceiver can also receive a signal of setting from the at least one control device and then outputs the received signal of setting to the microprocessor, to set the multi-alarm device.

7. The multi-alarm device of claim 6, wherein the at least one alarm comprises vehicle's horn honking, external and internal lights blinking, windshield wipers turning on to draw attention and impair visibility, or the vehicle can play a pre-recorded song to draw attention.

8. The multi-alarm device of claim 7, wherein when the lock component receives a signal of detection, the at least one alarm produces any and all of identified examples, depending on a user.

9. The multi-alarm device of claim 8, wherein the at least one securing means comprises locking transmission, doors, steering system, wheels, and brakes, when the signal of detection is received.

10. The multi-alarm device of claim 9, wherein when the lock component receives the signal of detection from the transceiver, the lock component outputs the received signal of detection to the microprocessor, which communicates with the at least one alarm, the at least one securing means, and the at least one control device to alert the user and engage the at least one alarms and the at least one securing means.

11. The multi-alarm device of claim 10, wherein the at least one control device comprises a key fob, a mobile application and a home security system.

12. The multi-alarm device of claim 11, wherein the lock component communicates with a wireless communications module and additional sensors to allow the multi-alarm device to pair with the mobile application on a smart device, the key fob, or the home security system.

13. The multi-alarm device of claim 12, wherein the smart device may be a cellular telephone or a remote control.

14. The multi-alarm device of claim 13, wherein the at least one control device comprises a plurality of function keys for operation by the user to enable or disable the lock component and to determine whether the at least one sensor module has been breached.

15. A multi-alarm device that is a specialized vehicle security device, the multi-alarm device comprising:
a lock component comprising at least one sensor module, an alarm, a microprocessor, a transceiver, a memory, a power supply unit, and the at least one securing means;
at least one control device comprising a key fob, a mobile application and a home security system;
at least one alarm comprising a vehicle's horn honking, external and internal lights blinking, windshield wipers turning on to draw attention and impair visibility, or the vehicle can play a pre-recorded song to draw attention; and
at least one securing means comprising locking transmission, doors, steering system, wheels, and brakes of a vehicle;
wherein the lock component communicates with a vehicle and with the at least one control device to alert a user;
wherein the at least one sensor module comprises a horizontal motion sensor, a vertical motion sensor, and an infrared sensor;
wherein if the vehicle is tampered with, the at least one sensor module immediately sends a signal of detection to the microprocessor and the at least one alarm; upon receipt of the signal of detection, the microprocessor outputs the signal of detection via the transceiver to the at least one control device;
wherein the transceiver can also receive a signal of setting from the at least one control device and then outputs the received signal of setting to the microprocessor, to set the multi-alarm device;
wherein when the lock component receives a signal of detection, the at least one alarm produces any and all of identified examples, depending on a user;
wherein when the lock component receives the signal of detection from the transceiver, the lock component outputs the received signal of detection to the microprocessor, which communicates with the at least one alarm, the at least one securing means, and the at least one control device to alert the user and engage the at least one alarms and the at least one securing means;
wherein the lock component communicates with a wireless communications module and additional sensors to allow the multi-alarm device to pair with the mobile application on a smart device, the key fob, or the home security system; and
further wherein the multi-alarm device prevents vehicle break-ins, theft, vandalism, and catalytic converter theft.

16. The multi-alarm device of claim 15 further comprising a plurality of indicia.

17. The multi-alarm device of claim 15, wherein the power supply unit comprises a plurality of DC batteries mounted therein for providing necessary working power.

18. The multi-alarm device of claim 17, wherein the power supply unit comprises a power detector that detects power status and a power alarm that engages when the power status is low.

19. The multi-alarm device of claim 15, wherein the at least one control device comprises a plurality of function keys for operation by the user to enable or disable the lock component and to determine whether the at least one sensor module has been breached.

20. A method of securing a vehicle and preventing a vehicle from being moved from its location, the method comprising the following steps:
providing a multi-alarm device comprising a lock component which communicate with the vehicle and multiple control devices, such as a mobile application, a key fob, and a home security system;
engaging the lock component and setting the alarm;
if the vehicle is tampered with, communicating with the lock component and multiple control devices;
activating at least one control device to send an alert to a user; and
locking the vehicle's transmission, doors, steering system, wheels, and brakes to prevent movement.
